(19) United States
(12) Patent Application Publication
(10) Pub. No.: US 2003/0199217 A1
(43) Pub. Date: Oct. 23, 2003

(54) Housewrap with drainage channels

(75) Inventors: Arthur H. Cashin, Nashville, TN (US); Gary W. Anderson, Mt. Juliet, TN (US); Susannah D. Gelotte, Antioch, TN (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Reemay, Inc.

(21) Appl. No.: 10/385,771

(22) Filed: Mar. 11, 2003

Related U.S. Application Data
(60) Provisional application No. 60/372,642, filed on Apr. 15, 2002.

(51) Int. Cl. B32B 3/00; B32B 3/26; D04H 1/00; D04H 3/00; D04H 5/00; D04H 13/00; D04H 1/74; D04H 3/05; B32B 27/12; B32B 27/32; D04H 3/16

(52) U.S. Cl. 442/394; 428/315.5; 442/327; 442/398; 442/401; 442/366

(57) ABSTRACT

A housewrap material for controlling moisture in the walls of a building includes a moisture vapor permeable, water impermeable sheet material having opposite surfaces with a plurality of drainage channels formed in the sheet material for directing the flow of liquid and for imparting to the sheet material a three-dimensional configuration. The sheet material has a crush resistance under a load of about 2.65 psi of at least 50%. In one embodiment, the integral drainage channels are defined by a plurality of generally parallel extending peaks and valleys that allow water to be drained from the wall. The composite nonwoven material has sufficient strength and stiffness to impart significant crush resistance to the composite, so that the integral drainage channels will not be collapsed or destroyed by the subsequent application of siding, stucco, paneling or the like to the building. Preferably, the composite sheet material has a crush resistance of at least 50% when subjected to a pressure of about 2.65 psi. This is particularly advantageous when the composite sheet material is used in conjunction with the application of stucco, although the advantages of the present invention are equally applicable when used in conjunction with a rigid exterior siding material.

### CROSS-REFERENCE TO RELATED APPLICATION

This application claims priority from U.S. Provisional Patent Application No. 60/372,642 filed Apr. 15, 2002.

### BACKGROUND OF THE INVENTION

This invention relates to a housewrap. More particularly, the invention relates to a housewrap material which can be used in building construction to control moisture in the building walls.

Managing or controlling moisture in the walls of a building is critical to the life of a building structure. Various types of sheet materials have been used in the construction of buildings as a barrier fabric to block water. These so-called housewrap products are typically applied over the sheathing layer of the building and beneath the building's exterior surface layer.

Various types of fabrics have been produced and sold commercially for this purpose. For example, one commonly used material is building felt. Other specialized housewrap products have been developed that will block the penetration of water, while allowing moisture vapor to pass through so that the building can breathe. One such commercially available product is manufactured and sold by DuPont under the trademark Tyvek® Homewrap®. This product is formed from flash spun high-density polyethylene fibers which are bonded together to form a nonwoven sheet material. Other commercially available housewrap products have used a woven or nonwoven substrate with a perforated film coating. For example, in Dunaway et al. U.S. Pat. No. 4,898,761, a barrier fabric is disclosed in which a polymer film is laminated to a nonwoven fabric, and the resulting composite sheet material is then needle-punched to provide micropores through the film. The nonwoven fabric is a spunbonded web formed of polyolefin filaments, and the polymer film can be applied to the nonwoven web by hot cast extrusion.

In certain regions of the country and in many construction techniques, especially with stucco construction, there is a need to drain liquid water from the interface between the exterior siding, paneling, brick, stucco, or other exterior finishing systems and the interior sheathing to prevent rotting of the wood components. Water can get into this interface in many ways. For example, water could penetrate through minute cracks in a stucco finish. Or if exterior wood siding or shingles are wet from rain and are then subjected to heat from the sun, water vapor evaporated from the shingles can penetrate into the interface. Also, in the winter, moisture from inside the building can condense on the surface of a cold housewrap barrier fabric. Additionally, if liquid water is not drained properly and improper construction techniques are used on the inner wall, mold and mildew can grow in the wall cavity and migrate to the interior wall surfaces.

Attempts have been made to provide construction materials that facilitate the drainage of water in a wall. In particular, spacing strips, laths or porous mats can be inserted between the barrier material and the outer wall to create channels through which water runoff can escape. Of course, this creates difficulties and adds expense to the building cost of the structure.

Another attempt at forming channels between the barrier material and outer surface is through forming channels in the barrier material itself. One such barrier material manufactured under the name StuccoWrap® by Dupont is similar to Dupont's Tyvek®, but barrier material is provided with a creped or textured surface intended to provide drainage channels. However, the drainage channels are susceptible to being crushed or flattened when the exterior siding material is applied.

Accordingly, a need exists for an economical barrier material with integral drainage channels and possessing superior strength and crush resistance.

### SUMMARY OF THE INVENTION

The present invention provides a housewrap material for controlling moisture in the walls of a building. The housewrap material includes a moisture vapor permeable, water impermeable sheet material having opposite surfaces. A plurality of drainage channels is formed in the sheet material for directing the flow of liquid and for imparting to the sheet material a three-dimensional configuration. The sheet material has a crush resistance under a load of about 2.65 psi (18.3×10³ Pa) of at least 50%.

In one embodiment, the integral drainage channels are defined by a plurality of generally parallel extending peaks and valleys that allow water to be drained from the wall. The composite nonwoven material has sufficient strength and stiffness to impart significant crush resistance to the composite, so that the integral drainage channels will not be collapsed or destroyed by the subsequent application of siding, stucco, paneling or the like to the building. Preferably, the composite sheet material has a crush resistance of at least 50% when subjected to a pressure of about 2.65 psi (18.3×10³ Pa). This is particularly advantageous when the composite sheet material is used in conjunction with the application of stucco, although the advantages of the present invention are equally applicable when used in conjunction with a rigid exterior siding material.

In one embodiment, the moisture vapor permeable, water impermeable sheet material comprises a composite of a nonwoven fabric substrate and an extrusion coated polyolefin film layer overlying one surface of the substrate. Preferably, nonwoven substrate is comprised of polymeric fibers randomly disposed and bonded to one another to form a high tenacity nonwoven web. The film layer is intimately bonded to the substrate to preferably provide a peel adhesion of at least 150 grams per inch (59 g/cm). The film layer suitably comprises a polyolefin polymer and at least 40% by weight of inorganic filler such as calcium carbonate. The film layer preferably has a basis weight of at least 25 grams per square meter. The composite sheet material has been stretched in at least one of the machine direction or the cross machine direction. This stretching operation renders the composite sheet material microporous. The composite sheet material has a moisture vapor transmission rate (MVTR) of at least 35 g/m²/24 hours at 50% relative humidity and 23° C. (73° F.). The composite sheet material also has a hydrostatic head of at least 55 cm, preferably at least 100 cm.

In some of the preferred embodiments, the drainage channels are defined by corrugations or pleats, which form alternating peaks and intervening valleys. When the housewrap is installed, the corrugations or pleats are preferably oriented to extend generally vertically, thus facilitating the downward drainage of water. In some embodiments, the corrugated or pleated sheet material of the present invention can be combined with a non-corrugated layer that is attached to one or both sides of the corrugated sheet material. These embodiments may be even more advantageous for stucco applications as the scratch coat is prevented from occupying any of the drainage channels established by the peaks and valleys of the composite sheet material. Further, adding non-corrugated or pleated layers provides even more crush resistance and maintains drainage channels on both sides of the barrier material.

Accordingly, the sheet material of the present invention provides integral drainage channels composed of a plurality of uniformly extending peaks and valleys that allow water to drain away from the surrounding walls. The composite sheet material of the present invention has a relatively high crush resistance, which allows the composite sheet material to be used in a wide variety of applications while maintaining the drainage plane.

### BRIEF DESCRIPTION OF THE DRAWINGS

Some of the features and advantages of the invention having been described, others will become apparent from the detailed description which follows, and from the accompanying drawings, in which

FIG. 1 is a perspective view of a housewrap material having a plurality of uniform peaks and valleys according to one embodiment of the present invention;

FIGS. 2A-2C are end views of pleated composite sheet materials according to the present invention;

FIGS. 3A-3C are end views of corrugated composite materials according to the present invention;

FIG. 4 is a schematic cross sectional view of a composite sheet material used in producing the corrugated composite sheet materials of the present invention;

FIG. 5 is a schematic diagram showing equipment suitable for producing the composite sheet material;

FIGS. 6 and 7 are graphs showing the compression loading properties of two control housewrap materials; and

FIG. 8 is a graph showing the compression loading properties of a housewrap material of the present invention.

### DETAILED DESCRIPTION OF ILLUSTRATIVE EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

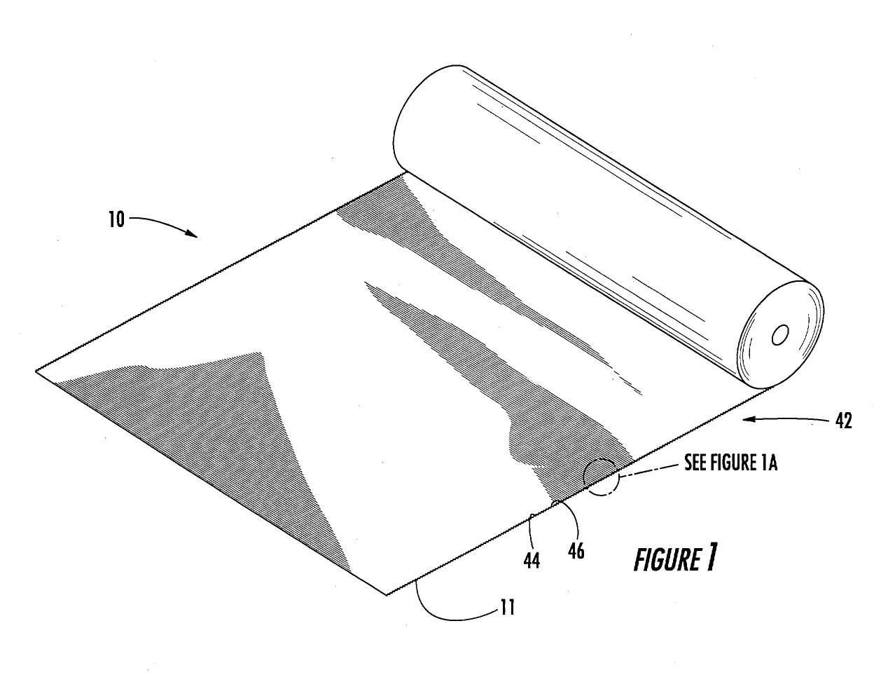

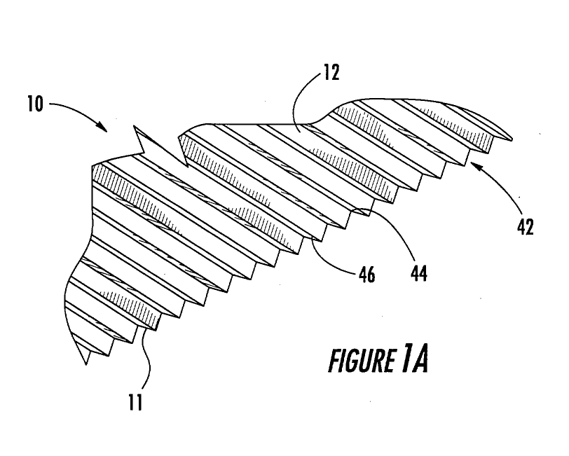

FIG. 1 is a perspective view of a housewrap material according to one embodiment of the present invention. In particular, the housewrap material includes a moisture vapor permeable, water impermeable barrier sheet material 10 having opposite front and rear surfaces. Drainage channels 42 are integrally formed in the sheet material and extend over substantially the entire extent of the front and rear surfaces of the sheet material. The drainage channels impart to the sheet material a three-dimensional configuration designed to form passageways along which water or other liquids present on the sheet material may drain downwardly by gravity. When the housewrap material is installed on the walls of a building, the drainage channels will provide continuous downward paths for the drainage of water. The paths are located within the thickness dimension of the fabric, i.e. between the outermost extent of the front and rear of the sheet material. The drainage channels can be formed in various configurations within the broad aspects of the present invention, so long as suitable paths are provided for the drainage of water by gravity.

In the embodiment shown in FIG. 1, the drainage channels are defined by a series of uniform, generally parallel peaks 44 separated by intervening valleys 46. In the embodiment shown, the peaks and valleys extend linearly, and are of substantially uniform spacing from one another and are of substantially uniform height, between root and crest. In the embodiment shown, the sheet material has a pleated construction, with the peaks and valleys created by sharply defined V-shaped creases or folds. In other embodiments, the sheet material may have a corrugated configuration, with peaks and valleys being rounded and forming a wavy or sinusoidal corrugated structure.

The housewrap material may be suitably supplied in roll form, with the sheet material 10 being of predetermined width and wound onto a core. When supplied in roll form, the drainage channels 42 are preferably oriented to extend widthwise of the material, in the cross direction (CD), so that the roll of housewrap material can be readily unrolled and wrapped around the outer perimeter of building structure with the drainage channels oriented in a generally vertical direction to facilitate drainage of water.

The sheet material 10 has sufficient strength, stiffness, and weight so that the drainage channels 42 are resistant to collapsing or crushing. Therefore, the channels 42 maintain their integrity and resist flattening or losing their shape during shipment of the housewrap material and installation on the building structure. They also withstand the forces of installing the overlying exterior building siding or surfacing material. For example, during the formation of a stucco exterior, a scratch coat (not shown) may be sprayed directly onto the surface of the sheet material 10 with a considerable force of impact. The laminate 10 of the present invention, however, resists flattening or crushing such that the channels 42 are maintained. As such, the scratch coat, which is formed from sand, concrete, and other coarse materials, forms a layer on the tops of the peaks 44 and any water that is present between the scratch coat and the valleys 46 is allowed to flow through the channels.

The crush resistance of the sheet material 10 is also advantageous when using the laminate in conjunction with an outer structure have a rigid surface, such as siding, solid panels, skirt boards, belly bands, and trim boards. More specifically, applying these types of materials directly or indirectly against the sheet material 10 typically exerts a compressive force as the outer structure is secured to the underlying supports. As such, where conventional barrier materials would flatten against the inner surface of the outer structure, the sheet material 10 of the present invention resists the compressive forces applied thereto such that the channels 42 are maintained so that water finding its way behind the outer structure is routed through the channels and away from the surrounding structures. In the embodiment shown in FIG. 1, the channels 42 are advantageously present on both exterior surfaces of the sheet material, so water is able to drain downwardly on either side of the laminate.

The channels preferably have a minimum height of about 1.5 mm. and preferably within the range of about 1.5 to 10 mm. The housewrap material has an overall thickness typically within the range of from about 1.5 to about 10 mm, although the thickness of housewrap material with the channels 42 can be up to 90 mm or greater. When the drainage channels are in the form of a pleated or corrugated configuration, the peaks are preferably spaced substantially uniformly apart a distance of from about 1 mm to about 10 mm.

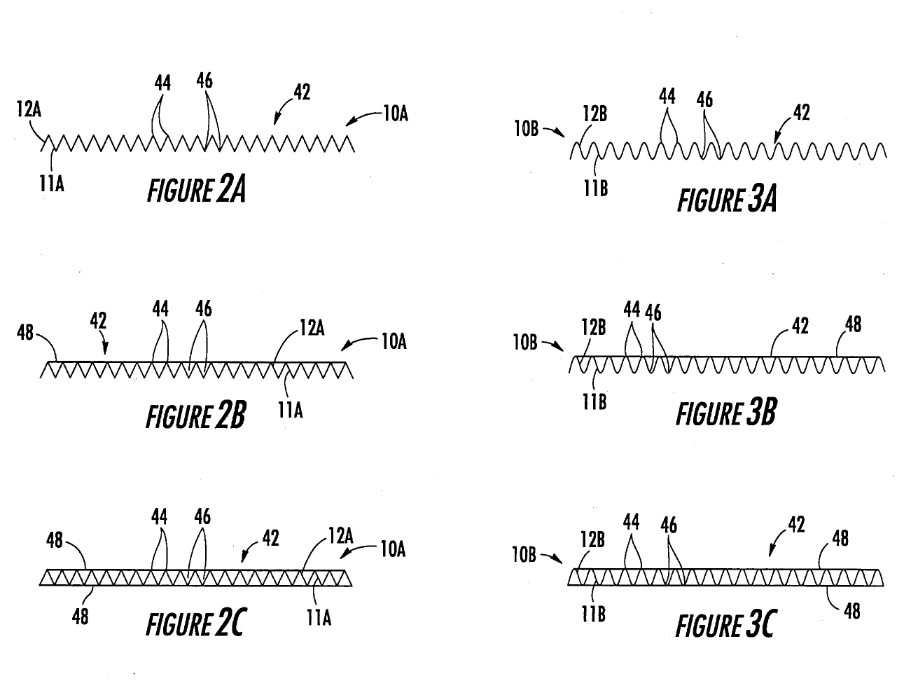

FIGS. 2A-2C show simplified cross-sectional or end views of various embodiments of a pleated composite laminate 10A structure according to the present invention. In particular, the pleats are defined by the uniform extending peaks 44 and valleys 46, which have generally sharp edges. In FIGS. 2B and 2C, an additional layer 48 is attached to one or both sides of the laminate 10. The additional layer 48 is preferably formed of the same material as the original laminate 10, but without the uniform extending peaks and valleys. The additional layer(s) 48 add even more crush resistance to the pleated laminate 10A and are particularly advantageous where building codes suggest double membrane barrier materials, or for stucco applications. For the latter, the additional layer 48 completely prevents the scratch coat from entering into the valleys 46 of the pleated laminate 10A. In addition, any water entering through the additional layer 48 due to nail holes or the like will likely be trapped and drained due to the extra barrier material used in the laminate 10A.

FIGS. 3A-3C show simplified cross-sectional or end views of various embodiments of a corrugated composite laminate 10B structure according to the present invention. In particular, the corrugated laminate 10B includes a similar structure to the pleated laminate 10A shown in FIGS. 2A-2C, but in this embodiment the peaks 44 and valleys 46 have smooth or rounded edges. Various machines are commercially available for pleating or corrugating sheet material into the configurations shown.

The barrier sheet material 10 used in the housewrap of the present invention is a preferably formed from a relatively stiff, sturdy nonwoven material which is water impermeable but permeable to moisture vapor. Various nonwoven material can be suitably employed. It is important that the sheet material have high tear strength coupled with sufficient stiffness and shape retention to be amenable to pleating or corrugating. These properties are important in achieving high crush resistance in the pleated or corrugated structure.

A preferred class of nonwoven material for use in manufacturing the housewrap of the present invention is a spunbond nonwoven. Spunbond nonwoven fabrics are formed by extruding molten thermoplastic material as continuous filaments from a plurality of fine, usually circular capillaries of a spinneret. The filaments are drawn and then randomly deposited onto a collecting surface. The filaments are bonded to form a coherent web. One specific example of a suitable nonwoven fabric possessing the required high levels of strength is a product sold under the trademark Typar® or Tekton® by BBA Nonwovens. This product is a spunbonded nonwoven fabric is made from fibers in the form of substantially continuous filaments of polypropylene. The filaments are cold-drawn and have a denier per filament of from 4 to 20. The filaments are bonded to one another at their crossover points to form a nonwoven sheet material having excellent strength characteristics. The spunbonded nonwoven substrate preferably has a grab tensile strength in at least one of the machine direction (MD) or the cross machine direction (CD) of at least 178 Newtons (40 lbs). The fabric is manufactured generally in accordance with Kinney U.S. Pat. No. 3,338,992, using mechanical draw rolls as indicated in FIG. 16. An example of another suitable spunbonded nonwoven fabric is a product sold by BBA Nonwovens under the trademark Reemay®. This spunbonded nonwoven fabric is formed of filaments of polyester.

In a particularly preferred embodiment, the sheet material 10 of the present invention is produced from a composite of a nonwoven fibrous substrate 11 and a polyolefin film layer 12. FIG. 3 illustrates such a sheet material, prior to pleating. The film layer 12 extends uninterruptedly and continuously over one surface of the nonwoven fibrous substrate 11. The film layer 12 has a strong adherence to the nonwoven fibrous substrate 11, such that the film layer and the substrate are not subject to delamination but instead are structurally combined with one another to form a composite material. The peel adhesion of the film layer 12 to the nonwoven fibrous substrate 11 is at least 59 g/cm (150 grams/inch), and preferably at least 78 g/cm (200 grams/inch). Most desirably, the adhesion is so great that the fibers of the substrate will tear or break before delamination will occur. This condition, known as “fiber tear,” occurs above about 98 g/cm (250 grams/inch). Peel adhesion of the film to the substrate is measured in accordance with the test procedure described below under the section entitled “Test Methods.”

The nonwoven fibrous substrate 11 is a high tenacity nonwoven fabric formed from polymeric fibers, which are randomly disposed and bonded to one another to form a strong nonwoven web. It is important for the substrate to have high tenacity and relatively low elongation in order to provide the strength and other physical properties required for a barrier material such as a housewrap. Preferably, the nonwoven substrate 11 has a grab tensile strength of at least 178 Newtons (40 pounds) in at least one of the machine direction (MD) or the cross-machine direction (CD). More preferably, the nonwoven substrate has a grab tensile strength of at least 267 N (60 pounds) in at least one of the MD and the CD. The required high tenacity and low elongation are achieved by selection of a manufacturing process in which the polymer fibers of the nonwoven fabric are drawn to achieve a high degree of molecular orientation, which increases fiber tenacity and lowers fiber elongation. Preferably, the manufacturing process involves mechanically drawing the fibers by means of draw rolls, as distinguished from other well-known manufacturing processes for nonwovens which utilize pneumatic jets or slot-draw attenuators for attenuating the freshly extruded fibers. Pneumatic attenuation of the fibers via jets or attenuators cannot achieve the high spinline stress required for orienting the polymer molecules to a high degree to develop the full tensile strength capability of the fibers. Mechanically drawing the fibers, on the other hand, allows for higher stresses in the fiber to orient the polymer molecules in the fibers and thereby strengthen the fibers. The drawing is carried out below the melting temperature of the polymer, after the polymer has cooled and solidified. This type of drawing process is conventionally referred to as “cold-drawing” and the thus-produced fibers may be referred to as “cold-drawn” fibers. Because the fibers are drawn at a temperature well below the temperature at which the polymer solidifies, the mobility of the oriented polymer molecules is reduced so that the oriented polymer molecules of the fiber cannot relax, but instead retain a high degree of molecular orientation. The degree of molecular orientation of the fiber can be determined by measuring the birefringence of the fiber or its degree of crystallinity. Cold-drawn fibers of the type used in the present invention are characterized by having a higher birefringence and a higher degree of crystallinity than fibers attenuated by pneumatic jets or slot-draw attenuators. Consequently, the individual fiber tenacity of a cold-drawn fiber is significantly greater than that of a fiber, which is attenuated or stretched by pneumatic jets or attenuators of the type, used in some spunbond nonwoven manufacturing processes.

Cold-drawing of a fiber-forming polymer is characterized by a phenomenon known as “necking down”. When the undrawn fiber is stretched, a reduction in diameter occurs in the fiber at a discrete location, i.e. “neck” instead of a gradual reduction in diameter. The morphology of a fiber drawn by cold-drawing is different from the morphology of a fiber, which has been attenuated or stretched while still in the molten state where the polymer molecules are mobile. The differences are evident from the x-ray diffraction patterns, from birefringence measurements, and from other analytical measurements.

Also contributing to the required high strength and low elongation of the substrate is the method or mechanism by which the fibers are bonded. Preferably, the nonwoven substrate is “area bonded” as distinguished from a “point bonded” or “patterned bonded” sheet material. In a point bonded or pattern bonded fabric, discrete bond points or zones are separated from one another by unbonded areas or zones. This type of bonding is often utilized for applications in which it is desired to preserve the softness of the fabric, such as nonwoven fabrics for diapers or hygiene products for example. In an “area bonded” fabric, the fiber bonds are not separated by unbonded areas, but instead are found throughout the area of the fabric. Because of the larger number of fiber-to-fiber bonds, area bonded fabrics are typically stronger than a point bonded fabric and are also less soft and less flexible. The fibers are adhered or bonded to one another throughout the fabric at numerous locations where the randomly deposited fibers overlie or cross one another.

The thermoplastic polymer fibers or filaments of the substrate 11 preferably contain pigments as well as chemical stabilizers or additives for retarding oxidation and ultraviolet degradation, and for imparting other desired properties such as antimicrobial, antimold, or antifungal. Typically, the stabilizers and additives are incorporated in the polymer at conventional levels, e.g., on the order of about 0.5 to 2% by weight. Typical stabilizers may include primary antioxidants (including hindered amine-light stabilizers and phenolic stabilizers), secondary antioxidants (such as phosphates), and ultraviolet absorbers (such as benzophenones). The polymer composition also preferably contains a pigment to render the nonwoven fabric opaque. In one preferred embodiment, the fibers are pigmented black using a black pigment, such as carbon black. If a white color is desired, titanium dioxide pigment can be used at comparable levels, or blends of titanium dioxide, with carbon black or with other colored pigments could be employed. The fibers or filaments are preferably circular in cross-section, although other cross-sectional configurations such as trilobal or multilobal cross-sections can be employed if desired.

The nonwoven fibrous substrate 11 should have a basis weight of at least 50 g/m², preferably from 60 to 140 g/m², and for certain preferred embodiments, a basis weight of from 80 to 100 g/m².

The composition from which the film layer 12 is formed is prepared by blending or compounding one or more thermoplastic polymers with suitable inorganic pore-forming fillers and with suitable additives, stabilizers and antioxidants. The polymer composition includes at least one polyolefin polymer component, such as polypropylene, propylene copolymers, homopolymers or copolymers of ethylene, or blends of these polyolefins. The polymer composition may, for example, comprise 100% polypropylene homopolymer, or blends of polypropylene and polyethylene. Suitable polyethylenes include linear low-density polyethylene (LLDPE). The polymer composition may also include minor proportions of other nonolefin polymers. The polymer composition is blended with inorganic pore-forming filler. Preferably, the pore-forming filler has a particle size of no more than about 5 microns. Examples of inorganic fillers include calcium carbonate, clay, silica, kaolin, titanium dioxide, diatomaceous earth, or combinations of these materials. Calcium carbonate is particularly preferred as a pore-forming filler, and it is preferred that the calcium carbonate be treated with calcium stearate to render it hydrophobic and to prevent agglomeration or clumping.

To achieve the high level of MVTR required for the present invention, it is preferred that the polymer and pore-forming filler blend comprise at least 40% by weight filler, and most desirably at least 50% by weight filler. The polymer composition may also include additional colorants or pigments, such as titanium dioxide, as well as conventional stabilizers and antioxidants, such as UV stabilizers, hindered amine light stabilizer compounds, ultraviolet absorbers, antioxidants, and antimicrobials.

The film-forming polymer composition is heated and mixed in an extruder, and is extruded from a slot die to form a molten polymer film. The molten polymer film is brought directly into contact with the nonwoven substrate 11 and the molten film composition is forced into intimate engagement with the fibrous web by directing the materials through a nip defined by a pair of cooperating rotating rolls.

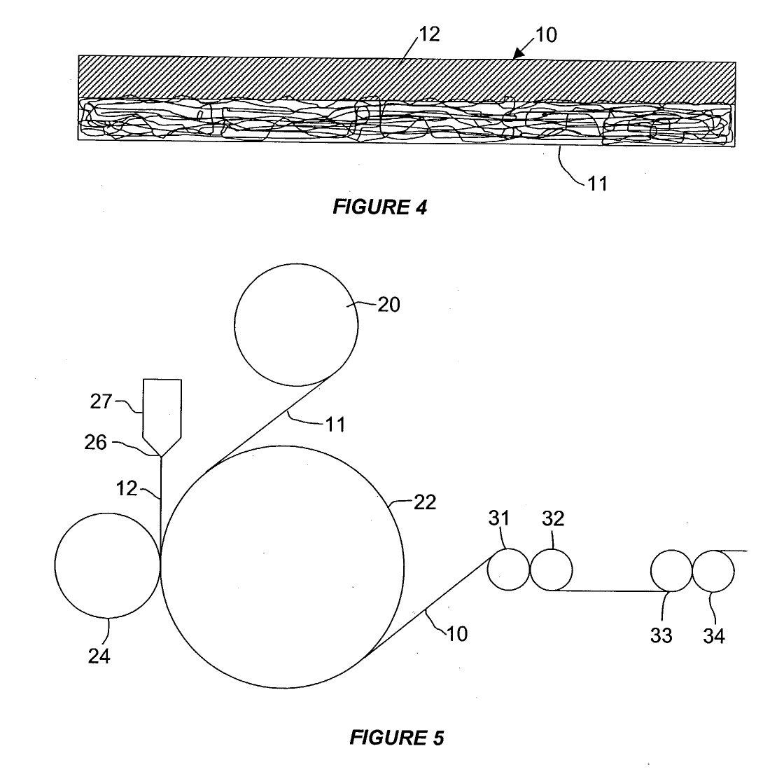

Suitable equipment for carrying out this process is shown schematically in FIG. 4. The nonwoven substrate 11 is unwound from a supply roll 20 and is directed onto and around a rotating chill roll 22. A cooperating pressure roll 24 defines a pressure nip with the chill roll 22. The polymer composition is extruded in the form of a film 12 of molten polymer from a slot die 26 of an extruder 27 directly into the nip defined between the cooperating rolls 22, 24. As the polymer film and the nonwoven substrate advance around the chill roll 22, the molten polymer composition cools and solidifies to form a substantially continuous polymer film layer adhered to one surface of the nonwoven substrate 11. At this point, the nonwoven web and film composite is substantially impermeable to moisture vapor. The composite is made microporous by stretching the material in the machine direction, or the cross-machine direction or in both the machine direction and the cross-machine direction. The fabric can be rolled-up and the stretching can be carried out in a separate subsequent operation, or alternatively, the stretching can be carried out in-line with the extrusion coating operation, as shown in FIG. 2.

Various stretching techniques can be employed to develop the micropores in the composite sheet material 10. A particularly preferred stretching method is a process known as “incremental stretching”. In an incremental stretching operation, the sheet material is passed through one or more cooperating pairs of intermeshing grooved or corrugated rolls which cause the sheet material to be stretched along incremental zones or lines extending across the sheet material. The stretched zones are separated by zones of substantially unstretched or less stretched material. The incremental stretching can be carried out in the cross machine direction (CD) or the machine direction (MD) or both, depending upon the design and arrangement of the grooved rolls. Example of apparatus and methods for carrying out incremental stretching are described in U.S. Pat. Nos. 4,116,892; 4,153,751; 4,153,664; and 4,285,100, incorporated herein by reference.

FIG. 4 illustrates equipment suitable for a continuous in-line stretching operation using first and second pairs of intermeshing rolls. The first pair of intermeshing rolls 31, 32 is provided with a grooved surface configured for achieving incremental stretching in the cross-direction (CD) of the material. The grooves extend circumferentially around the rolls and produce a series of alternating stretched and non-stretched zones extending linearly along the machine direction of the composite material. The amount of incremental stretching is controlled by varying the engagement depth of the intermeshing rolls. The stretching operation is carried generally in accordance with the teachings of U.S. Pat. No. 5,865,926, the disclosure of which is incorporated herein by reference.

Preferably, the fabric is subjected to stretching in the machine direction as well as in the cross-direction. For this purpose, the fabric is run through a second set of rolls 33, 34 designed for achieving MD stretching. The second pair of intermeshing rolls 33, 34 have a grooved surface configured for achieving stretching in the machine direction (MD) of the material, with the grooves extending generally parallel to the rotational axis of the rolls. The additional stretching operation in the machine direction increases the moisture vapor transmission properties of the material and provides an aesthetically pleasing surface appearance.

The film layer is preferably applied to the fabric at a minimum basis weight of 25 g/m², and most desirably, from 30 to 50 g/m².

The resulting composite material has an overall basis weight of from 60 to 140 g/m² and a MVTR of at least 35 g/m²/24 hr. at 50% relative humidity and 23° C. (73° F.), and more desirably and MVTR of at least 100. The product preferably also has a Gurley porosity of at least 400 seconds and a hydrostatic head of at least 55 cm.

The product also preferably has an Air Leakage Rate less than 0.02 L/(s·m²), and more desirably less than 0.015 L/(s·m²) measured by ASTM 283.

The thus-produced composite material is then mechanically deformed to create a series of uniform closely spaced parallel alternating peaks and intervening valleys in the composite material, defining pleats or corrugations. The mechanical deformation is carried out by passing the composite material through a cooperating pair of appropriately configured grooved rollers while the composite material is heated. The composite material has sufficient inherent stiffness to retain the deformed pleated or corrugated shape upon cooling. The grooved rolls can be configured to produce pleats with sharply defined peaks and valleys, or they may pleats with rounded peaks and valleys resembling corrugations. The pleats preferably have a height within the range of from about 1 mm to 5 mm (0.04 inch to about 0.2 inch) and are closely spaced at a density of from about 2 to 6 pleats per centimeter (5 to 15 pleats per inch).

### TEST METHODS

In the description above and in the non-limiting examples that follow, the following test methods were employed to determine various reported characteristics and properties. ASTM refers to the American Society for Testing and Materials, AATCC refers to the American Association of Textile Chemists and Colorists, INDA refers to the Association of the Nonwovens Fabrics Industry, and TAPPI refers to the Technical Association of Pulp and Paper Industry.

Air Leakage Rate is measured by ASTM E283, entitled “Standard Test Method for Rate of Air Leakage Through Exterior Windows, Curtain Walls, and Doors.” This is a standard for laboratory measurement of air leakage through buildings.

Basis Weight is a measure of the mass per unit area of a sheet and was determined by ASTM D-3776, which is hereby incorporated by reference, and is reported in g/m²

Fabric thickness is measured in accordance with ASTM D 1777—Standard Test Method for Thickness of Textile Materials (1996)

Grab Tensile Strength The grab tensile test is a measure of breaking strength of a fabric when subjected to unidirectional stress. This test is known carried out in accordance with ASTM D 4632—Standard Test Method for Grab Breaking Load and Elongation of Geotextiles, 1991 (reapproved 1996).

Gurley Porosity is a measure of the resistance of the sheet material to air permeability, and thus provides an indication of its effectiveness as an air barrier. It is measured in accordance with TAPPI T-460 (Gurley method). This test measures the time required for 100 cubic centimeters of air to be pushed through a one-inch diameter sample under a pressure of approximately 4.9 inches of water. The result is expressed in seconds and is frequently referred to as Gurley Seconds.

Hydrostatic Head (hydrohead) is a measure of the resistance of a sheet to penetration by liquid water under a static pressure. The test is conducted according to AATCC-127, which is hereby incorporated by reference, and is reported in centimeters.

Moisture Vapor Transmission Rate (MVTR) is determined by ASTM E 96, Standard Test Methods for Water Vapor Transmission of Materials; 1995, Procedure A.

Peel Adhesion. The adhesion of the film layer to the nonwoven substrate layer is measured by delaminating a portion of the film from the nonwoven substrate and measuring the force required to peel the film from the nonwoven. The peel adhesion is expressed in terms of grams of peel force per inch of width.

Tear Strength is measured in accordance with ASTM D 4533 (trapezoidal tear).

Tensile Elongation is measured in accordance with ASTM Method D882 for the high tenacity nonwoven substrates used in the present invention. For lighter basis weight nonwovens used in the hygiene industry, ASTM Method D 5035 is the accepted standard.

Crush resistance is measured by the following procedure: A test instrument used for measuring thickness of nonwoven fabrics in accordance with the procedures of INDA IST 120.1 (ASTM D5729-97) was modified in order to obtain a higher pressure on the sheet material to impart a crushing force. The original thickness of the fabric was measured according to the above test procedure under a force of 0.068 psi. Then an increased compressive force was applied and the fabric thickness was again measured. The percent reduction in thickness was calculated. An average of 5 readings was used. The crush resistance is calculated as 100% minus the percentage compression under a given load.

### EXAMPLE 1

Typar® 3201, a spun-bonded polypropylene nonwoven fabric produced by Reemay, Inc. of Old Hickory, Tenn., was used as the fibrous nonwoven substrate for producing a high MVTR extrusion coated composite sheet material. Typar® 3201 is a spunbond polypropylene nonwoven fabric having a basis weight of 64 g/m², a thickness of 0.305 mm (12 mils), an MD grab tensile strength of 351 N (79 lbs.), a CD grab tensile strength of 329 N (74 lbs.), a trapezoidal tear strength of 165 N (37 lbs.) in the MD and 151 N (34 lbs.) in the CD, and a mullen burst strength of 393 Pa (57 psi). This substrate was extrusion-coated with a polypropylene polymer composition containing about 50 percent by weight calcium carbonate filler. The polymer film was extruded onto the substrate at two different basis weights: 25 g/m² and 35 g/m². The resulting composite was incrementally stretched in the CD using equipment similar to that shown in FIG. 2. Samples of the fabric were taken at three locations across the width of the fabric, near the left, center, and near the right, and the physical properties of these samples were evaluated. Average values for the three samples are shown in Table 1 below.

TABLE 1

| Test | Sample 1 | Sample 2 |
|---|---|---|
| Film Basis Weight (g/m²) | 25 | 35 |
| Peel adhesion (g/1 inch) | 215 | Fiber tear |
| Hydrohead (cm) | >100 | >100 |
| Gurley Porosity | >400 | >400 |
| Thickness, mm (mils) | 0.055 (21.7) | 0.455 (17.9) |
| Grab Tensile, MD N (lbs). | 329 (74) | 369 (83) |
| Grab Tensile, CD N (lbs.) | 298 (67) | 302 (68) |
| Trap. Tear, MD N (lbs.) | 146 (32.8) | 170 (38.3) |
| Trap. Tear, CD N (lbs.) | 121 (27.2) | 126 (28.3) |

### EXAMPLE 2

Typar 3201, a spunbond polypropylene nonwoven fabric having a basis weight of 64 g/m² (1.9 oz/yd²), was extrusion coated as in Example 1, using a polypropylene with about 50 percent by weight calcium carbonate filler applied at a basis weight of 35 g/m². The fabric was incrementally stretched in the CD by passing through incremental stretching rollers set at 1.4 mm (55 mils) and at 1.5 mm (60 mils) engagement, respectively. Samples of the fabric were taken at three locations across the width of the fabric, near the left, center, and near the right, and the physical properties of these samples were evaluated. Average values for the three samples are shown in Table 2 below.

TABLE 2

| Test | Sample 3 | Sample 4 | Sample 5 |
|---|---|---|---|
| Stretch Roll setting mm (mils) | 1.4 (55) | 1.4 (55) | 1.5 (60) |
| Peel adhesion (g/1 inch) | Fiber tear | Fiber tear | Fiber tear |
| Hydrohead (cm) | >55 | >55 | >55 |
| Gurley Porosity | >400 | >400 | >400 |
| Thickness mm (mils) | 0.41 (16) | 0.43 (17) | 0.51 (20) |
| Grab Tensile, MD N (lbs.) | | 427 (96) | 489 (110) |
| Grab Tensile, CD N (lbs.) | | 325 (73) | 333 (74.8) |
| Trap. Tear, MD N (lbs.) | | 191 (42.9) | 144 (32.3) |
| Trap. Tear, CD N (lbs.) | | 114 (25.6) | 82.7 (18.6) |

### EXAMPLE 3

In this example, the tensile properties of several of the high tenacity spunbond nonwoven substrates used in the present invention (Typar®) are contrasted with commercially available spunbond nonwoven fabrics. In Table 3, Typar spunbond nonwoven fabric in three different basis weights is compared to a spunbond polypropylene fabric produced by a Reicofil spunbond process. The Typar nonwoven fabric is a spunbond nonwoven fabric formed from cold-drawn polypropylene filaments. In the nonwoven fabric produced by the Reicofil process, the polypropylene filaments are attenuated by a slot draw attenuator located in the spinline directly beneath where the molten polymer filaments are extruded.

TABLE 3

| Product | Typar | Typar | Typar | Reicofil |
|---|---|---|---|---|
| Basis Weight g/m² (oz/yd²) | 57 (1.7) | 64 (1.9) | 78 (2.3) | 57 (1.7) |
| MD Grab Tensile N (lbs.) | 316 (71) | 365 (82) | 472 (106) | 160 (36) |
| CD Grab Tensile N (lbs.) | 294 (66) | 334 (75) | 436 (98) | 129 (29) |
| MD Trap Tear N (lbs.) | 151 (34) | 165 (37) | 178 (40) | |
| CD Trap Tear N (lbs.) | 138 (31) | 151 (34) | 147 (33) | |

### EXAMPLE 4

In Table 4 below, the tensile elongation of a 78 g/m² (2.3 oz/yd²) Typar nonwoven fabric substrate is compared with that of two lighter basis weight polypropylene spunbond nonwovens produced for hygiene applications using a slot-draw pneumatic attenuation process.

TABLE 4

| Product | Typar | Hygiene | Hygiene |
|---|---|---|---|
| Basis Weight (g/m²) | 78 | 30.5 | 27.1 |
| MD Strip Tensile Elongation (%) | 71 | 120 | 100 |
| CD Strip Tensile Elongation (%) | 59 | 190 | 175 |

Tables 5-9 illustrate the properties of the composite nonwoven fabrics used in the present invention, before the composite materials have been pleated or corrugated.

TABLE 5
Composite Physical Properties
Composite Tensile Strength
Composite Grab Tensiles

| | MD Grab Tensile | CD Grab Tensile | |
|---|---|---|---|
| Sample Description | Strength N (lbs.) | Strength N (lbs.) | Notes |
| Coated 64 g/m² Typar | 329 (74) | 267 (60) | ASTM Method D5034 |
| Coated 78 g/m² Typar | 480 (108) | 480 (108) | ASTM Method D1682 |
| | | | and D1117 Section 7 |

TABLE 6
Substrate Tensile Elongation
Strip Tensiles - ASTM Method D882

| | MD Strip Tensile | CD Strip Tensile |
|---|---|---|
| Sample Description | Elongation % | Elongation % |
| Coated 64 g/m² Typar | 37 | 33 |
| Coated 78 g/m² Typar | 55 | 56 |

TABLE 7
Composite Trapezoidal Tear Strength
Trap Tear Tensiles

| | MD Trap Tear | CD Trap Tear | |
|---|---|---|---|
| Sample Description | Strength N (lbs.) | Strength N (lbs.) | Notes |
| Coated 64 g/m² Typar | 129 (29) | 178 (40) | ASTM Method D5733 |
| Coated 78 g/m² Typar | 120 (27) | 173 (39) | ASTM Method D1117 |
| | | | Section 14 |

TABLE 8
Composite Air Leakage Rate
Air Leakage Rate - ASTM E-283, at 75 Pa

| Sample Description | Air Leakage Rate ft³/min ft² | Notes |
|---|---|---|
| Coated 64 g/m² Typar | 0.0006 | Highest value measured at 75 Pa |

TABLE 9
Composite Vapor Transmission Rate
Vapor Transmission Rate - ASTM E96 - Procedure A

| Sample Description | MVTR g/m²/24 hours | |
|---|---|---|
| Coated 64 g/m² Typar | 51 | |
| Coated 78 g/m² Typar | 132 | Test Duration: 5 hours |

### EXAMPLE 5

Microporous composite fabrics produced generally as described in Example 1 were pleated with two different configurations of pleats, rounded and sharp. The pleat height and spacing was as follows:

TABLE 10

| Sample | A | B | C |
|---|---|---|---|
| Pleat configuration | Rounded | Sharp | Sharp |
| Basis Weight (g/m²) | 78 | 64 | 64 |
| Pleat Height mm (in.) | 3.2 (0.125) | 3.2 (0.125) | 1.9 (0.075) |
| Pleat Spacing per cm | 3.5 (9) | 4.3 (11) | 4.7 (12) |
| (per inch) | | | |

In Table 11, the crush resistance of a commercially available housewrap product identified as Tyvek® StuccoWrap (identified in the table as Control 1) is compared with two products of the present invention, Sample A and Sample B from Table 10 using the first procedure referenced above.

TABLE 11
Crush Resistance

| Sample Description | Control 1 | | Sample A | | Sample B | |
|---|---|---|---|---|---|---|
| Load (lb/in²) | Thickness | % comp. | Thickness | % comp. | Thickness | % comp. |
| 0.068 | 0.035 | — | 0.107 | — | 0.124 | — |
| 0.21 | 0.036 | 0.00 | 0.099 | 7 | 0.125 | 0.00 |
| 2.65 | 0.012 | 66 | 0.097 | 9 | 0.121 | 2 |
| 7.3 | 0.006 | 82 | 0.094 | 13 | 0.119 | 4 |

As can be clearly seen in Table 11, the percent compression for Control 1 rapidly degraded between a compression of 0.21 psi and 2.65 psi, while pleated materials according to the present invention, namely Sample A and Sample B did not compress nearly as much.

The data from table 11 can also be viewed in terms of crush resistance, where crush resistance is defined as the difference between the uncompressed state (100%) and the percent compression:

Crush Resistance=100%−%Compression

When viewed in this manner, the materials show strikingly different performance. In particular, at a pressure of 2.65 psi, Control 1 had crush resistance of 34.48%, while Samples A and B had crush resistance of 90.47% and 97.42%, respectively. Even more striking was the crush resistance at 7.3 psi, where Control 1 had crush resistance of only 17.82% (substantially flattened), while Samples A and B had crush resistance of 87.48% and 96.28%, respectively.

### EXAMPLE 6

In this example, samples were subjected to compression loading by an Instron® tensile tester equipped with compression anvils in the form of round plates 4 square inches in area that come together and are capable of measuring compressive force with a load force of at least 250 pounds force (lbf). The sample is placed between the two anvils and a gap, determined by the thickness of the material to be tested, is set and the test begins from this point for every test. The lower anvil is stationary. There is a Load Cell connected to the upper anvil which determines the amount of force applied to the sample. The upper anvil moves at a rate of 0.100 in./min. The compressive strain values are calculations of the amount of sensitivity related to the maximum amount of the load cell verses gap setting and amount of movement in the original setting, and represent deformation of the sample.

The pleated housewrap of the invention (Sample A) was compared to two controls: Control 1, a commercially available creped polyethylene housewrap product identified as Tyvek® StuccoWrap, and Control 2, a commercially available builder's paper such as Fortifiber® Super Jumbo Tex®.

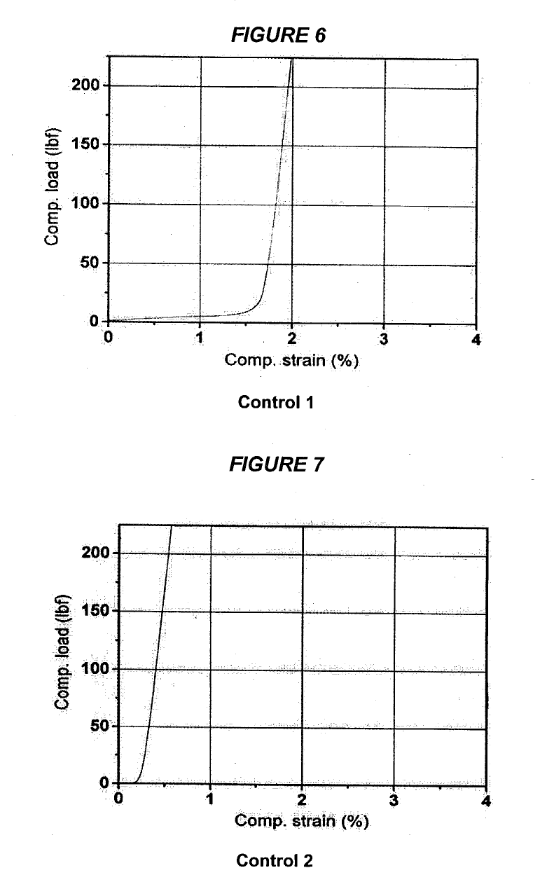

Referring now to the graph of FIG. 6, which represents Control 1, the data illustrates almost complete compression immediately (a near vertical line indicates no further compression possible).

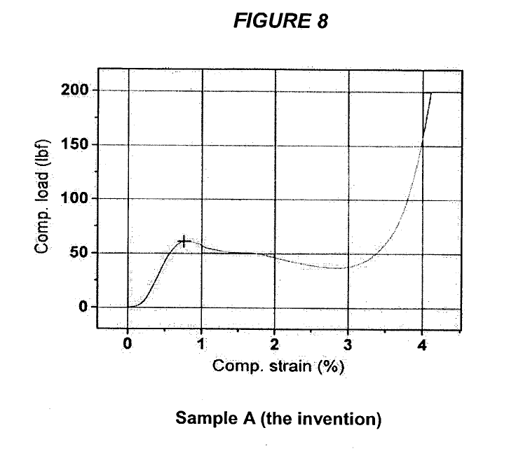

The graph of FIG. 7 represents compression data for Control 2, a commercially available builder's paper. Builder's paper is flat and lacks any sort of drainage channels. As such, this graph provides a baseline reference of what has historically has been used behind siding, brick, and stucco. Similar to FIG. 6, the builder's paper compressed immediately, which is shown in FIG. 7 as a nearly vertical line.

FIG. 8 represents compression data for Sample A, a housewrap material (Typar®) according to the present invention. As shown, Sample A resisted compression up to about 60 lbf before starting to crush (see the initial spike at crosshairs). As the material compresses, the compression resistance decreases until no further compression is possible, where the line goes near vertical as in FIGS. 6 and 7 up to the limit of the load cell.

Table 12 represents the data for the graphs in FIGS. 6, 7 and 8. Thirty-one (31) samples were tested for each material.

TABLE 12

| Material | # | Mean | Range | Thickness |
|---|---|---|---|---|
| Control 1 | 31 | CNM* | CNM | 0.011 mm |
| Control 2 | 31 | CNM | CNM | 0.015 mm |
| Sample A (present invention) | 31 | 50.61bf | 37-63 | 0.090 mm |

*CNM = Could Not Measure

Drainage testing was also performed. In particular, water drainage times were measured with a drainage test device manufactured by HyGlo Inc. of Valley City, Utah on Control 1, Control 2 and Sample A. Two tests were performed. The first test series was performed by inserting a 12″×12″ piece of uncompressed material into the test device with a gap set to the measured thickness of the test sample. This provided the maximum drainage possible. One thousand (1000) milliliters of water was then poured into the top of the test device, and the time to complete drainage was recorded. Table 13 represents the first test series data.

TABLE 13

| | | |
|---|---|---|
| Control 1 | 0.019 mm | 28 seconds |
| Control 2 | 0.015 mm | 900 seconds |
| Sample A (present invention) | 0.095 mm | 10 seconds |

The second test series was performed by repeating the first test series, except that the test samples were compressed to the maximum ability of the Instron test unit. Table 14 represents the second test series data.

TABLE 14

| | | |
|---|---|---|
| Control 1 | CC* | 140 seconds |
| Control 2 | CC | 900 seconds |
| Sample A (present invention) | CC | 10 seconds |

Viewing the first and second test series together, the housewrap material of the present invention is shown to provide a superior weather resistant barrier product with far greater crush resistance and drainage capability compared to the two controls.

Accordingly, the present invention provides an advantageous nonwoven composite having a plurality of uniform extending peaks and valleys defining channels for directing water that migrates, flows, condenses, or otherwise finds its way behind the outer wall structure of the building away from the outer wall and other surrounding surfaces such that the water cannot collect and harm the surrounding surfaces and structural components of the building. Advantageously, the channels of the nonwoven composite are substantially crush resistant, such that the composite of the present invention can withstand a wide variety of building processes, such as stucco application as well as the application of planar wall surfaces, without losing the channels formed by pleating, corrugating, or the like. As such, the composite of the present invention is more robust and prevents structural damage to the building longer than conventional barrier materials.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A housewrap for controlling moisture in the walls of a building, comprising: a moisture vapor permeable, water impermeable sheet material having opposite surfaces, a plurality of drainage channels formed in said sheet material for directing the flow of liquid therealong, said drainage channels imparting to the sheet material a three-dimensional configuration, and said sheet material having a crush resistance under a load of about 2.65 psi of at least 50%.

2. The housewrap according to claim 1, wherein the sheet material has a crush resistance of at least about 70% under a load of about 2.65 psi.

3. The housewrap according to claim 1, wherein the composite sheet material has a crush resistance of at least about 90% under a load of about 2.65 psi.

4. The housewrap according to claim 1, wherein the composite sheet material has a crush resistance of at least about 70% under a load of about 7.3 psi.

5. The housewrap according to claim 1, wherein the composite sheet material has a crush resistance of at least about 85% under a load of about 7.3 psi.

6. The housewrap according to claim 1 wherein said moisture vapor permeable, water impermeable sheet material comprises a nonwoven fabric substrate and an extrusion coated polyolefin film layer overlying one surface of said substrate and intimately bonded thereto.

7. The housewrap according to claim 6, wherein the nonwoven substrate is formed from substantially continuous cold-drawn, molecularly oriented filaments.

8. The housewrap according to claim 7, wherein said nonwoven fibrous substrate comprises a spunbonded nonwoven fabric formed of randomly disposed substantially continuous cold-drawn, molecularly oriented polypropylene filaments.

9. The housewrap according to claim 7, wherein said spunbonded nonwoven fabric is an area bonded fabric in which the filaments are bonded to one another throughout the fabric at locations where the randomly disposed filaments overlie or cross one another.

10. The housewrap according to claim 6, wherein said film layer has a basis weight of at least 25 g/m².

11. The housewrap according to claim 6, wherein said sheet material has a basis weight of from 60 to 140 g/m².

12. The housewrap according to claim 6, wherein the sheet material has a basis weight of from 80 to 110 g/m².

13. The housewrap according to claim 6, wherein said sheet material has an air leakage rate of less than 0.015 L/(s·m²).

14. The housewrap according to claim 1 wherein said drainage channels are defined by a plurality of alternating peaks and intervening valleys.

15. The housewrap according to claim 14, wherein said plurality of peaks and valleys are sharply defined and in the form of pleats.

16. The housewrap according to claim 14, wherein said plurality of peaks and valleys are rounded and in the form of corrugations.

17. The housewrap according to claim 14, additionally including a layer of planar sheet material positoned on one side of said vapor permeable, water impermeable sheet material and attached thereto.

18. The housewrap according to claim 14, additionally including first and second layers of planar sheet material positoned on opposite sides of said vapor permeable, water impermeable sheet material and attached thereto.

19. A roll of housewrap material comprising the housewrap of claim 14 wound about a core, the sheet material being of predetermined, substantially uniform width, and wherein said peaks and valleys extend widthwise of the sheet material.

20. A housewrap for controlling moisture in the walls of a building, comprising: a moisture vapor permeable, water impermeable composite sheet material having opposite surfaces, said composite sheet material comprising:
a nonwoven substrate comprising polymeric fibers randomly disposed and bonded to one another to form a nonwoven web having a grab tensile strength of at least about 40 pounds in at least one of the machine direction (MD) and the cross-machine direction (CD); and an extrusion coated polyolefin film layer overlying one surface of said substrate and intimately bonded thereto, said film layer comprising a polyolefin polymer and at least 40% by weight inorganic filler; said film layer having micropores formed therein,
a plurality of drainage channels formed in said composite sheet material for directing the flow of liquid therealong, said drainage channels imparting to the composite sheet material a three-dimensional configuration, and said composite sheet material having a crush resistance under a load of about 2.65 psi of at least 50%.

21. The housewrap according to claim 20 wherein said composite sheet material has a moisture vapor transmission rate (MVTR) of at least about 35 g/m²/24 hr. @50% RH and 23° C. and a hydrostatic head of at least 55 cm.

22. The housewrap according to claim 20, wherein said nonwoven fibrous substrate comprises a spunbonded nonwoven fabric formed of randomly disposed substantially continuous cold-drawn, molecularly oriented polypropylene filaments.

23. The housewrap according to claim 22, wherein said spunbonded nonwoven fabric is an area bonded fabric in which the filaments are bonded to one another throughout the fabric at locations where the randomly disposed filaments overlie or cross one another.

24. The housewrap according to claim 20, wherein said composite sheet material has a basis weight of from 60 to 140 g/m².

25. The housewrap according to claim 20, wherein said composite sheet material has an air leakage rate of less than 0.015 L/(s·m²).

26. A roll of housewrap material comprising the composite sheet material of claim 20 wound about a core, the sheet material being of predetermined, substantially uniform width, and wherein said drainage channels are defined by a plurality of alternating peaks and intervening valleys extending widthwise of the sheet material.

27. A housewrap comprising
a composite sheet material including a spunbonded nonwoven fabric formed of randomly disposed substantially continuous filaments bonded to one another throughout the fabric to form a nonwoven web having a grab tensile strength of at least 40 pounds in at least one of the machine direction (MD) or the cross-machine direction (CD), and an extrusion coated polyolefin film layer overlying one surface of said substrate and intimately bonded thereto, said film layer comprising a polyolefin polymer and at least 40% by weight inorganic filler; said film layer having micropores formed therein by stretching;
a plurality of drainage channels formed in said composite sheet material for directing the flow of liquid therealong, said drainage channels imparting to the sheet material a three-dimensional configuration,
the sheet material having a moisture vapor transmission rate (MVTR) of at least 135 g/m²/24 hr. @50% RH and 23° C., a Gurley porosity of at least 400 sec/100 cc, a hydrostatic head of at least 55 cm

28. The housewrap according to claim 27, wherein said drainage channels are defined by a plurality of pleats extending across the fabric and forming alternating peaks and intervening valleys.

29. The housewrap according to claim 27, wherein the composite sheet material has a crush resistance of at least 50% under a load of about 2.65 psi.

30. The housewrap according to claim 27, wherein the composite sheet material has a crush resistance of at least 70% under a load of about 2.65 psi.

31. The housewrap according to claim 27, wherein said composite sheet material has a basis weight of from 60 to 140 g/m².

32. A housewrap comprising
a composite sheet material including a spunbonded nonwoven fabric formed of randomly disposed substantially continuous filaments bonded to one another throughout the fabric to form a nonwoven web, and an extrusion coated polyolefin film layer overlying one surface of said substrate and intimately bonded thereto, said film layer comprising a polyolefin polymer and at least 40% by weight inorganic filler; said film layer having micropores formed therein by stretching, the fabric having a moisture vapor transmission rate (MVTR) of at least 35 g/m²/24 hr. @50% RH and 23° C., a Gurley porosity of at least 400 sec/100 cc, a hydrostatic head of at least 55 cm;
a plurality of pleats extending across the composite sheet material and forming alternating peaks and intervening valleys, the pleats having a height of from 0.04 inch to 0.2 inch and a density of from about 5 to 15 pleats per inch, and the pleats defining drainage channels for directing the flow of liquid therealong and imparting to the sheet material a three-dimensional configuration.

33. The housewrap according to claim 32, additionally including a planar nonwoven fabric layer positoned on one side of said composite sheet material and attached thereto.

34. The housewrap according to claim 32, additionally including first and second planar nonwoven fabric layers positoned on opposite sides of said composite sheet material and attached thereto.

35. A housewrap comprising
a composite sheet material including a spunbonded nonwoven fabric formed of randomly disposed substantially continuous filaments bonded to one another throughout the fabric to form a nonwoven web, and a moisture vapor permeable, water impermeable polyolefin film layer overlying one surface of said substrate and intimately bonded thereto;
a plurality of pleats formed in said composite sheet material forming alternating peaks and intervening valleys imparting a three-dimensional configuration to said composite sheet material and defining drainage channels for directing the flow of liquid therealong, and
a planar layer of a moisture vapor permeable, water impermeable sheet material positioned on at least one side of said composite sheet material and attached thereto.
